(19) United States
(12) Patent Application Publication
(10) Pub. No.: US 2004/0243488 A1
(43) Pub. Date: Dec. 2, 2004

(54) Storage medium rental system

(76) Inventors: Masaya Yamamoto, Hirakata (JP); Masataka Minami, Arcadia, CA (US); Motoji Ohmori, Hirakata (JP); Tomoyuki Okada, Nara (JP)

Correspondence Address: WENDEROTH, LIND & PONACK, L.L.P., 2033 K STREET N. W., SUITE 800, WASHINGTON, DC, 20006-1021, US

(21) Appl. No.: 10/445,328

(22) Filed: May 27, 2003

(51) Int. Cl. G06F 17/60

(52) U.S. Cl. 705/30

(57) ABSTRACT

A rental system includes a terminal apparatus, a BD player, and a server apparatus. At renting BD storing pieces of content, the terminal apparatus writes rental information including content ID identifying each piece of content, viewing status, and content key, to the user's memory card. The player plays back content when viewing status is “viewing-permitted” or “additionally-viewed”, and when viewing status is “not-viewed”, changes to “additionally-viewed”, and plays it back. At returning BD, the terminal apparatus calculates a content rental fee when “additionally-viewed” is in the memory card, and charges the fee to the user. The terminal apparatus reads use-history information about playback of content from the memory card, internally stores it as use information, and regularly transmits the use information to the server apparatus managed by the content provider. The server apparatus calculates a content fee using the stored use information, and charges the fee to the rental agent.

### BACKGROUND OF THE INVENTION

(1) Field of the Invention

The present invention relates to a technique for renting a storage medium storing digital content.

(2) Description of the Related Art

Storage mediums such as DVDs for digitally storing work including movies and music have been increasingly widespread. High-volume information can be digitally stored in such storage mediums as DVDs, and can be used semi-permanently. By taking advantage of such storage mediums, a rental-service business for renting storage mediums storing movies, music, etc., has been developed to create a huge market.

Japanese Laid-open Patent Application No. H11-167769 discloses a system in which unauthorized use of information is prevented and a fee is charged to a user in accordance with an amount of information used, without relying on a network etc. The user sets a disc and an IC card in a playback apparatus, so that the playback apparatus reads playback management information stored in the disc and playback permission information stored in the IC card. The playback apparatus then compares the playback management information and the playback permission information, and judges whether playback is permitted. When judging that the playback is permitted, the playback apparatus plays back soft information stored in the disc. In parallel with the playback, the playback apparatus detects use information. At the end of playback, the playback apparatus writes the use information to the IC card. When the user returns the disc at the rental shop, the use information is read from the IC card, and a rental fee is calculated using the read use information indicating an amount of soft information used. The user is then required to pay the rental fee calculated in accordance with the amount of soft information used.

Also, specifications for the digital high-definition recording format “Blu-ray Disc” have been established. The Blu-ray Disc repeatedly enables the recording and playback of digital high-definition video data of two hours or more on a 12 cm CD/DVD size disc. Using a 405 nm blue-violet laser, the Blu-ray Disc writes signals on a recording track corresponding to almost half (0.32 μm) of that of a DVD. According to this format, up to 27 GB of data can be written on a single layer 12 cm size disc. For a double layer single-sided disc, a recording capacity of 50 GB is provided, realizing recording of four hours with digital high-definition image quality and recording of 24 hours with standard broadcast image quality.

As described above, the Blu-ray Disc specifications enable recording of larger capacity than a DVD, and recording of large-volume data and high-quality video. As such, applications of the Blu-ray Disc specifications are desired to be diversified.

### SUMMARY OF THE INVENTION

To satisfy the above-mentioned desire, the present invention aims at providing a storage medium rental system, a playback apparatus, a rental-shop apparatus, a method, and a program that can improve the convenience of a content provider, a rental agent, and a user, in renting a large-capacity storage medium storing digital work to a user.

To achieve the above aim, a rental system of the present invention includes a rental-shop apparatus, a playback apparatus, and a server apparatus.

A rental storage medium stores a plurality of pieces of content. When the rental agent rents the storage medium to the user, the rental-shop apparatus operated by the rental agent writes a plurality of pieces of rental information corresponding one-to-one to the plurality of pieces of content, to a memory card owned by the user. Each piece of rental information is composed of a “content ID” identifying the corresponding piece of content, a “viewing status”, and a “content key”. Here, the “viewing status” has a value either showing “viewing-permitted” or “not-viewed”. The viewing status “viewing-permitted” indicates that a rental fee for the corresponding piece of content has been paid. The viewing status “not-viewed” indicates that a rental fee for the corresponding piece of content has not been paid.

To play back a piece of content stored in the rental storage medium, the user sets the storage medium and the memory card in the playback apparatus, and designates to the playback apparatus, the piece of content to be played back. The playback apparatus plays back the designated piece of content, when the viewing status corresponding to the designated piece of content is either “viewing-permitted” or “additionally-viewed”, and when the viewing status is “not-viewed”, changes the viewing status to “additionally-viewed”, and then plays back the piece of content. Also, when the piece of content is played back, the playback apparatus writes use-history information indicating the playback, to the memory card.

When the user returns the storage medium to the rental agent, the memory card is set in the rental-shop apparatus. When the viewing status “additionally-viewed” is stored in the memory card, the rental-shop apparatus calculates an additional rental fee for the additionally-viewed piece of content, and charges the calculated rental fee to the user. Also, the rental-shop apparatus reads use-history information indicating playback of content from the memory card, and internally stores the read use-history information as use information.

The server apparatus internally stores use information transmitted thereto. Also, using the use information internally stored therein, the server apparatus calculates a content use fee at regular intervals, and charges the calculated content use fee to the rental agent.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 is a block diagram showing the construction of a rental system 1;

FIG. 2 shows the structure of data stored in a BD 50;

FIG. 3 is a block diagram showing the construction of a terminal apparatus 10;

FIG. 4 is a block diagram showing the construction of a memory card 40;

FIG. 5 is a block diagram showing the construction of a BD player 20;

FIG. 6 is a block diagram showing the construction of a server apparatus 30;

FIG. 7 is a flowchart showing an operation of the terminal apparatus 10 when the BD 50 is rented to a user who is a member of a rental shop, to be continued to FIG. 8;

FIG. 8 is a flowchart showing the operation of the terminal apparatus 10 when the BD 50 is rented to the user, to be continued to FIG. 9;

FIG. 9 is a flowchart showing the operation of the terminal apparatus 10 when the BD 50 is rented to the user, continued from FIG. 8;

FIG. 10 is a flowchart showing an operation of the BD player 20 for playing back encrypted content stored in the BD 50, to be continued to FIG. 11;

FIG. 11 is a flowchart showing the operation of the BD player 20 for playing back encrypted content stored in the BD 50, continued from FIG. 10;

FIG. 12 is a flowchart showing an operation of the terminal apparatus 10 when the BD 50 is returned, to be continued to FIG. 13;

FIG. 13 is a flowchart showing the operation of the terminal apparatus 10 when the BD 50 is returned, continued from FIG. 12;

FIG. 14 is a flowchart showing an operation of the terminal apparatus 10 for transmitting information relating to an amount of information used; and

FIG. 15 is a flowchart showing an operation of a server apparatus 30.

### DESCRIPTION OF THE PREFERRED EMBODIMENT

### 1. First Embodiment

The following describes a rental system 1 as a first embodiment of the present invention.

### 1.1 Construction of the Rental System 1

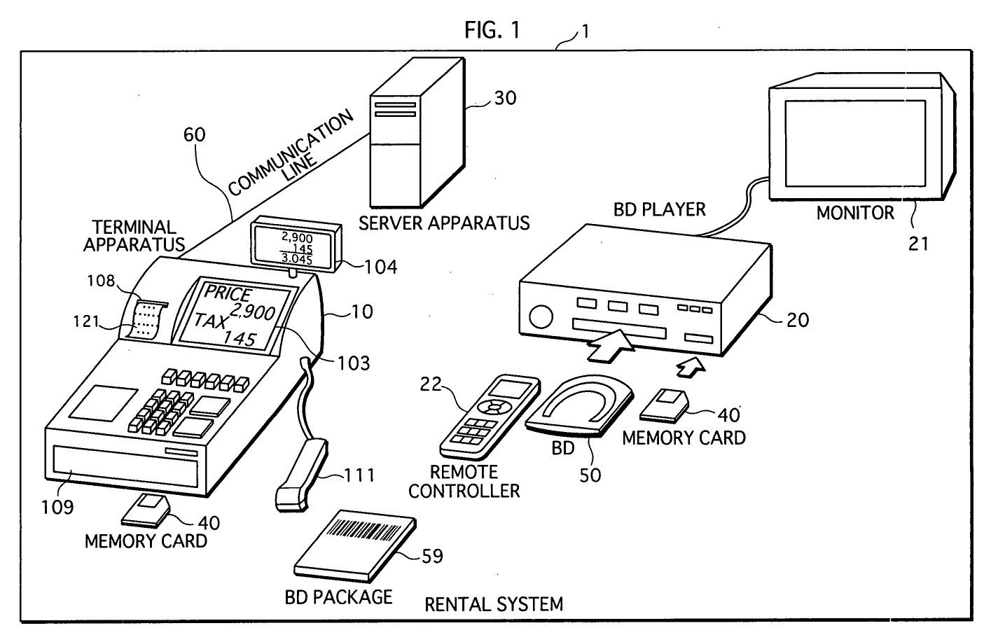

As shown in FIG. 1, the rental system 1 is roughly composed of a terminal apparatus 10, a BD player 20, and a server apparatus 30.

The terminal apparatus 10 is designed to manage rental of a storage medium to a user, and is connected to the server apparatus 30 via a communication line 60. The terminal apparatus 10 is placed at a shop run by a rental agent (at a rental shop), and its operations are managed by the rental agent. A BD 50 is a storage medium storing a plurality of pieces of digital work such as movies in compliance with the Blu-ray Disc specifications. When the rental agent rents the BD 50 to the user, a memory card 40 owned by the user is set in the terminal apparatus 10. The user selects a piece of digital work that the user wants, from the pieces of digital work stored in the BD 50, and pays a rental fee for the selected piece of digital work. Then, the terminal apparatus 10 writes a rental information table that is described later, to the memory card 40 owned by the user.

The BD player 20 is designed to play back digital work stored in the storage medium in compliance with the Blu-ray Disc specifications, and is placed at the user's home. To play back one piece of digital work stored in the BD 50 that the user has rented, the user sets the BD 50 and the memory card 40 in the BD player 20. The BD player 20 judges whether the piece of digital work stored in the BD 50 is permitted to be played back, based on the rental information table stored in the memory card 40. When judging that the piece of digital work is permitted to be played back, the BD player 20 plays back the piece of digital work. Here, the user can freely play back the piece of digital work for which the user has paid its rental fee. For a piece of digital work for which the user has not paid its rental fee, the user can play back the piece of digital work on condition that the user pays the rental fee later. The BD player 20 updates the rental information table stored in the memory card 40 according to playback instructed by the user.

When the user returns the BD 50 to the rental agent, the memory card 40 is set in the terminal apparatus 10, so that the terminal apparatus 10 calculates a rental fee to be paid later, based on the rental information table stored in the memory card 40, and charges the calculated rental fee to the user. The terminal apparatus 10 internally stores information relating to use of digital work by the user (hereafter referred to as “use information”), and transmits the use information to the server apparatus 30.

The server apparatus 30 receives the use information, and internally stores the use information. At regular intervals, the server apparatus 30 charges the rental agent a fee calculated in accordance with the use information. A content provider that provides a storage medium storing digital work to the rental agent manages and operates the server apparatus 30.

The following describes each component of the rental system 1.

### 1.2 Construction of the BD 50

The BD 50 is an optical magnetic disc that can store high-volume information in compliance with the Blu-ray Disc specifications. As shown in FIG. 1, the BD 50 is wrapped in a BD package 59. A barcode is printed on the surface of the BD package 59. The barcode indicates a package ID that is described later.

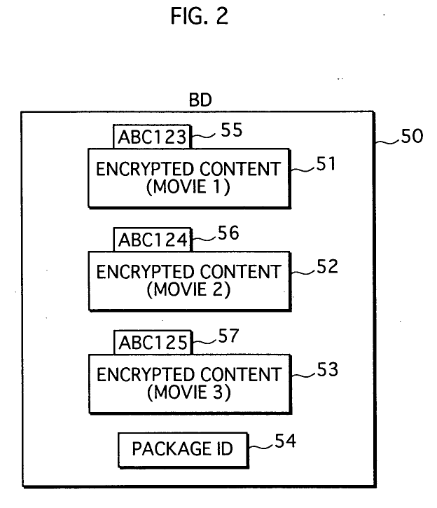

As one example shown in FIG. 2, the BD 50 prestores pieces of encrypted content 51 to 53, and a package ID 54. The pieces of encrypted content 51 to 53 are respectively given content IDs 55 to 57.

The encrypted content 51 has been generated by encrypting a piece of content, i.e., digital work such as a movie, using a content key. The content key used to encrypt the piece of content is unique to the piece of content. Here, the DES (Data Encryption Standard) is employed as an encryption algorithm. The same applies to the encrypted content 52 and the encrypted content 53.

It should be noted here that three movies upon which the pieces of encrypted content 51 to 53 are based are related to one another. For example, the first, second, and third pieces of content may respectively be part I, part II, and part III of the movie “Galaxy War”.

The content IDs 55 to 57 are identification numbers uniquely identifying the pieces of encrypted content 51 to 53 respectively.

The package ID 54 is an identification number uniquely identifying the BD 50.

### 1.3 Construction of the Terminal Apparatus 10

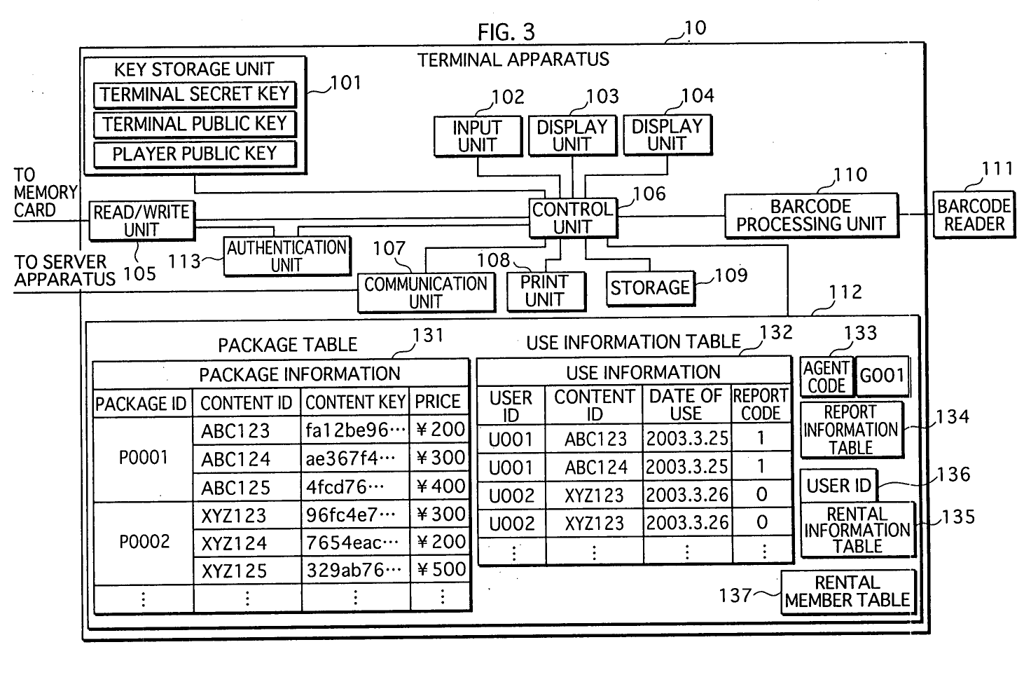

As shown in FIG. 3, the terminal apparatus 10 is roughly composed of a key storage unit 101, an input unit 102, a display unit 103, a display unit 104, a read/write unit 105, a control unit 106, a communication unit 107, a print unit 108, a storage 109, a barcode processing unit 110, an information storage unit 112, and an authentication unit 113. Also, a barcode reader 111 is connected to the terminal apparatus 10.

The terminal apparatus 10 is designed to manage rental of storage mediums to users, and also functions as a register apparatus to charge rental fees to the users and store the rental fees.

The terminal apparatus 10 is specifically a computer system that is roughly composed of a microprocessor, a ROM, a RAM, a hard disk unit, a display unit, and a keyboard. The hard disk unit stores computer programs. The functions of the terminal apparatus 10 are realized by the microprocessor operating in accordance with the computer programs.

### (1) Key Storage Unit 101

The key storage unit 101 is provided so as to allow no access from outside. As shown in FIG. 3, the key storage unit 101 prestores a terminal secret key, a terminal public key, and a player public key.

The terminal secret key is key data with a 160-bit length assigned to the terminal apparatus 10.

The terminal public key is a public key generated based on the terminal secret key, using a public key encryption algorithm, and is key data with a 160-bit length. Here, the public key encryption algorithm is based on the Elliptic Curve Cryptography. The Elliptic Curve Cryptography is well known, and therefore is not described here.

The player public key is key data with a 160-bit length generated by the BD player 20. The player public key is described later.

### (2) Information Storage Unit 112

As shown in FIG. 3, the information storage unit 112 has an area for storing a package table 131, a use information table 132, an agent code 133, a report information table 134, a rental information table 135, and a rental member table 137.

### Package Table 131

As shown in FIG. 3, the package table 131 has an area for storing a plurality of pieces of package information. Each piece of package information corresponds to one BD package.

Each piece of package information is composed of one package ID and a plurality of pieces of content information. Each piece of content information is composed of a content ID, a content key, and a price.

The package ID is identification information for uniquely identifying the corresponding BD package.

Each piece of content information corresponds to one piece of encrypted content stored in a BD wrapped in the corresponding BD package. The content ID is identification information identifying the corresponding piece of encrypted content stored in the BD. The content key is a decryption key for decrypting the piece of encrypted content. The price indicates a rental fee to be paid for renting the piece of content.

### Use Information Table 132

As shown in FIG. 3, the use information table 132 has an area for storing a plurality of pieces of use information.

Each piece of use information is composed of a user ID, a content ID, a date of use, and a report code. The user ID is identification information for identifying a user who is a member of the rental shop. The content ID is identification information for identifying a piece of content played back by the user. The date of use is a date, month, and year when the user plays back the piece of content. The report code is either “0” or “1”, and “0” indicates that use of the piece of content by the user has yet to be reported to the content provider, and “1” indicates that the use of the piece of content by the user has been reported to the content provider.

### Agent Code 133

The agent code 133 is identification information for identifying the rental agent that manages and operates the terminal apparatus 10, and is prestored in the information storage unit 112.

### Report Information Table 134

The report information table 134 is a data table temporally generated when use of content by the user is reported to the content provider.

The report information table 134 includes a plurality of pieces of report information. Each piece of report information is composed of a user ID, a content ID, and a date of use.

The user ID and the content ID are the same as described above, and therefore are not described here. The date of use is a date, month, and year when a piece of content identified by the corresponding content ID was played back by the user.

### Rental Information Table 135

The rental information table 135 is a data table temporarily generated when a BD is rented to the user. The rental information table 135 is given a user ID 136 identifying the user.

The rental information table 135 has the same construction as a rental information table (described later) that is written to the memory card 40. The rental information table 135 is not described here.

### Rental Member Table 137

The rental member table 137 is for storing information about users who are registered as members of the rental shop run by the rental agent. The rental member table 137 has an area for storing a plurality of pieces of member information.

Each piece of member information corresponds to one member.

Each piece of member information is composed of a user ID, a member name, an address, a birth date, and a telephone number. Here, the user ID is an identification number for identifying the corresponding member. The member name is a name of the member. The address indicates a location of residence of the member. The birth date is a date, month, and year when the member was born. The telephone number is a number of a telephone owned by the member.

### (3) Authentication Unit 113

The authentication unit 113 performs mutual authentication with the memory card 40 via the read/write unit 105 when the memory card 40 is set in the terminal apparatus 10. Here, the authentication is of a challenge-response type. The authentication of a challenge-response type is well known, and therefore is not described in detail here.

The authentication unit 113 sends a success message indicating a success of the mutual authentication to the control unit 106 when the mutual authentication between the authentication unit 113 and the memory card 40 is successful, and sends a failure message indicating a failure of the mutual authentication to the control unit 106 when the mutual authentication is unsuccessful.

When the mutual authentication is unsuccessful, the terminal apparatus 10 thereafter does not transmit and receive information to and from the memory card 40.

### (4) Read/Write Unit 105

The read/write unit 105 bidirectionally transmits and receives information between the control unit 106 and the memory card 40 under control by the control unit 106, and between the authentication unit 113 and the memory card 40 under control by the authentication unit 113.

### (5) Barcode Reader 111

The barcode reader 111 optically reads a barcode printed on the surface of the BD package 59, generates read-information corresponding to the barcode, and outputs the generated read-information to the barcode processing unit 110.

### (5) Barcode Processing Unit 110

The barcode processing unit 110 receives the read-information from the barcode reader 111, generates a package ID using the received read-information, and outputs the generated package ID to the control unit 106.

### (7) Control Unit 106

### User ID Issuing Process

The following describes a process of issuing a user ID. In the user ID issuing process, when the authentication performed by the authentication unit 113 in the terminal apparatus 10 is successful and the authentication performed by an authentication unit 403 in the memory card 40 is successful, the control unit 106 receives a member name, an address, a birth date, and a telephone number from the input unit 102. Also, the control unit 106 newly generates a user ID. Following this, the control unit 106 additionally writes a piece of member information that is composed of the generated user ID, the received member name, address, birth date, and telephone number, into the rental member table 137 held by the information storage unit 112.

Also, the control unit 106 writes the generated user ID to the memory card 20 via the read/write unit 105.

### BD Rental Process

The following describes a process of renting a BD. In the BD rental process, when the authentication performed by the authentication unit 113 in the terminal apparatus 10 is successful and the authentication performed by the authentication unit 403 in the memory card 40 is successful, the control unit 106 initializes the rental information table 135 and the user ID 136 in the information storage unit 112. For this initialization, the control unit 106 sets the user ID 136 at a null value. Also, the control unit 106 sets, in the rental information table 135, each area corresponding to the viewing status at a value showing “not-viewed”, and other areas at a null value.

Following this, the control unit 106 outputs a request to read a user ID to the memory card 40 via the read/write unit 105. The control unit 106 receives the user ID via the read/write unit 105, and writes the received user ID as the user ID 136, into the information storage unit 112.

The control unit 106 has an area for storing a total amount showing a total of rental fees to be charged to the user. The control unit 106 initializes the total amount by setting a value of the total amount at “0”.

For each BD package to be rented to the user, the control unit 106 executes the processing (a) to (c).

(a) A package ID is received from the barcode processing unit 110, and a piece of package information including the received package ID is read from the package table 131.

(b) One package ID, a plurality of content IDs, and content keys included in the read piece of package information are written into the rental information table 135.

(c) For each content ID included in the read piece of package information, the following processing (c1) to (c3) is executed:

(c1) A content ID included in the piece of package information is outputted to the display unit 103 and the display unit 104.

(c2) An instruction indicating whether or not to rent a piece of content identified by the displayed content ID is received from the input unit 102.

(c3) When an instruction to rent is received, the viewing status corresponding to the content ID is set to show “viewing-permitted”, and a rental fee corresponding to the content ID included in the piece of package information is added to the total amount in the rental information table 135.

When the operator of the terminal apparatus 10 receives payment of the total amount of rental fees from the user, the control unit 106 reads a terminal secret key from the key storage unit 101, reads the rental information table 135, and subjects the read rental information table to a digital signature algorithm using the read terminal secret key, to generate terminal signature data. The control unit 106 then writes the generated terminal signature data and the read rental information table to the memory card 40, via the read/write unit 105.

The digital signature algorithm employed here complies with the ElGamal signature scheme, which bases its security on the discrete logarithm problem on elliptic curves.

### BD Returning Process

The following describes a process of returning a BD.

The control unit 106 has an area to be used to calculate an additional rental fee.

In the BD returning process, when the authentication performed by the authentication unit 113 in the terminal apparatus 10 is successful and the authentication performed by the authentication unit 403 in the memory card 40 is successful, the control unit 106 first initializes the additional rental fee by setting a value of the additional rental fee at “0”, and then reads the rental information table, terminal signature data, and player signature data from the memory card 40 via the read/write unit 105. Here, there may be a case where player signature data is not present in the memory card 40. In this case, of course, the control unit 106 fails to read the player signature data.

Following this, the control unit 106 reads the terminal public key from the key storage unit 101, and subjects the read rental information table and terminal signature data to a digital signature verification algorithm. The digital signature verification algorithm employed here complies with the ElGamal signature scheme, which bases its security on the discrete logarithm problem on elliptic curves.

When the verification is successful, the control unit 106 assumes that the rental information table has not been changed and that pieces of content whose rental fees are not paid have not been viewed. The control unit 106 therefore deletes the rental information table and the terminal signature data stored in the memory card 40. Here, in this case, player signature data should not be present in the memory card 40. The BD returning process ends.

When the verification is unsuccessful, the control unit 106 reads the player public key from the key storage unit 101, and subjects the read rental information table and the player signature data to the digital signature verification algorithm using the read player public key.

When the verification is unsuccessful, the control unit 106 assumes that information has been written in an unauthorized manner to the memory card 40. The control unit 106 therefore outputs the corresponding memory information to the display units 103 and 104. The BD returning process ends.

On the other hand, when the verification is successful, the control unit 106 executes the following processing (a) to (b) for each content ID and its viewing status included in the read rental information table.

(a) A judgment is performed as to whether the viewing status is “additionally-viewed”.

(b) When the judgment is performed as to whether the viewing status is “additionally-viewed”,

(b1) a price corresponding to the content ID is read from the package table 131,

(b2) the read price is added to the additional rental fee, and

(b3) the user ID, content ID, date of use, and report code are written into the use information table 132. Here, the date of use is the date of use read from the use-history information table 412 in the memory card 40, and corresponds to the content ID. The report code is “0”.

Following this, when the additional rental fee is not “0”, the operator of the terminal apparatus 10 receives payment of the additional rental fee from the user.

Finally, the control unit 106 deletes the rental information table, the terminal signature data, and the player signature data stored in the memory card 40.

### Use Amount Information Transmission Process

The following describes a process of transmitting information relating to an amount of information used.

The control unit 106 transmits, at regular intervals, i.e., once at the end of rental operations of every day, a report information table showing an amount of information used by content users, to the server apparatus 30 in the following way.

(a) The report information table 134 held by the information storage unit 112 is initialized. Here, the initialization of the report information table 134 means to write a null value therein.

(b) The following processing (c) to (d) is performed for each piece of use information included in the use information table 132.

(c) A piece of use information is read from the use information table 132.

(d) A judgment is performed as to whether a report code included in the read piece of use information is “0” or “1”.

(d-1) When the report code is “0”, the user ID, content ID, and date of use included in the read piece of use information are written into the report information table 134.

(d-2) The report code included in the piece of use information table 132 is changed to “1”.

(e) The agent code 133 is read from the information storage unit 112.

(f) The read agent code 133 and the report information table 134 are transmitted to the server apparatus 30 via the communication unit 107 and the communication line 60.

### (8) Input Unit 102, Display Unit 103, Display Unit 104, Print Unit 108, and Storage 109

The input unit 102 receives an input from the operator of the terminal apparatus 10, and outputs the received input to the control unit 106. Also, the display unit 103 and the display unit 104 receive information to be displayed, from the control unit 106, and displays the received information.

The print unit 108 prints various information under control by the control unit 106.

The storage 109 stores bank notes and coins.

### (9) Communication Unit 107

The communication unit 107 is connected to the server apparatus 30 via the communication line 60, and transmits and receives information between the control unit 106 and the server apparatus 30.

### 1.4 Construction of the Memory Card 40

The memory card 40 is provided to the user as being bundled with the BD player 20.

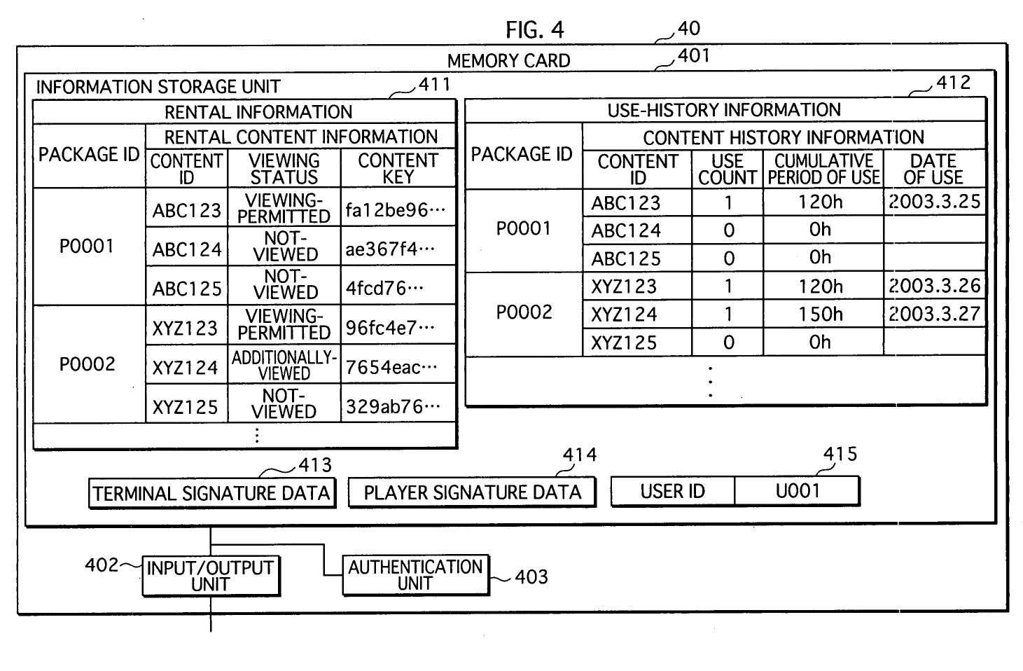

As shown in FIG. 4, the memory card 40 is roughly composed of an information storage unit 401, an input/output unit 402, and an authentication unit 403.

The memory card 40 is specifically a computer system that is roughly composed of a microprocessor, a ROM, and a RAM. The RAM stores computer programs. The functions of the memory card 40 are realized by the microprocessor operating in accordance with the computer programs.

The following describes each component of the memory card 40.

### (1) Information Storage Unit 401

As shown in FIG. 4, the information storage unit 401 has an area for storing a rental information table 411, a use-history information table 412, terminal signature data 413, player signature data 414, and a user ID 415.

### Rental Information Table 411

The rental information table 411 has an area for storing one or more pieces of rental information. Each piece of rental information corresponds to one BD package, and includes one package ID and a plurality of pieces of rental content information. Each piece of rental content information corresponds to a piece of encrypted content included in the BD package, and includes a content ID, a viewing status, and a content key.

The package ID is identification information identifying the corresponding BD package.

The content ID is identification information identifying the corresponding piece of encrypted content included in the BD package.

The viewing status has a value showing “not-viewed”, “viewing-permitted”, or “additionally-viewed”. The viewing status having a value showing “not-viewed” indicates that a rental fee of a piece of content identified by the corresponding content ID is not paid in advance, and the piece of content has not been played back but is permitted to be played back by the user on condition that the rental fee is paid later.

The viewing status having a value showing “viewing-permitted” indicates that a rental fee of a piece of content identified by the corresponding content ID has been paid by the user, and the piece of content is permitted to be played back by the user.

The viewing status having a value showing “additionally-viewed” indicates that a rental fee of a piece of content identified by the corresponding content ID is not paid in advance, but the piece of content has been played back by the user and is permitted to be played back by the user on condition that the rental fee is paid later.

The content key is a decryption key to be used to decrypt a piece of encrypted content identified by the corresponding content ID.

### Use-History Information Table 412

The use-history information table 412 has an area for storing one or more pieces of use-history information.

Each piece of use-history information corresponds to one BD package, and includes one package ID and a plurality of pieces of content history information. Each piece of content history information corresponds to a piece of encrypted content included in the BD package, and includes a content ID, a use count, a cumulative period of use, and a date of use.

The package ID is identification information identifying the corresponding BD package.

The content ID is identification information identifying the corresponding piece of encrypted content included in the BD package.

The use count indicates the number of times a piece of content identified by the corresponding content ID has been played back.

The cumulative period of use indicates a cumulative time period during which a piece of content identified by the corresponding content ID has been played back.

The date of use indicates a date, month, and year when a piece of content identified by the corresponding content ID was played back lastly.

### Terminal Signature Data 413, Player Signature Data 414, and User ID 415

The terminal signature data 413 is signature data generated by the terminal apparatus 10.

The player signature data 414 is signature data generated by the BD player 20.

The user ID 415 is identification information for identifying the user.

### (2) Input/Output Unit 402

The input/output unit 402 reads information from the information storage unit 401, and outputs the read information to an external apparatus into which the memory card 40 is set. Also, the input/output unit 402 receives information from the external apparatus, and writes the received information into the information storage unit 401. Here, the external apparatus is the terminal apparatus 10 or the BD player 20.

### (3) Authentication Unit 403

The authentication unit 403 performs mutual authentication with the external apparatus via the input/output unit 402 when the memory card 40 is set in the external apparatus. Here, the authentication is of a challenge-response type. The authentication of a challenge-response type is not described in detail here as it is well known.

Here, the external apparatus is the terminal apparatus 10 or the BD player 20.

The authentication unit 403 controls the input/output unit 402 to transmit and receive information between the information storage unit 401 and the external apparatus, when the mutual authentication with the external apparatus is successful. When the mutual authentication with the external apparatus is unsuccessful, the authentication unit 403 controls the input/output unit 402 not to thereafter transmit and receive information between the information storage unit 401 and the external apparatus.

### 1.5 Construction of the BD Player 20

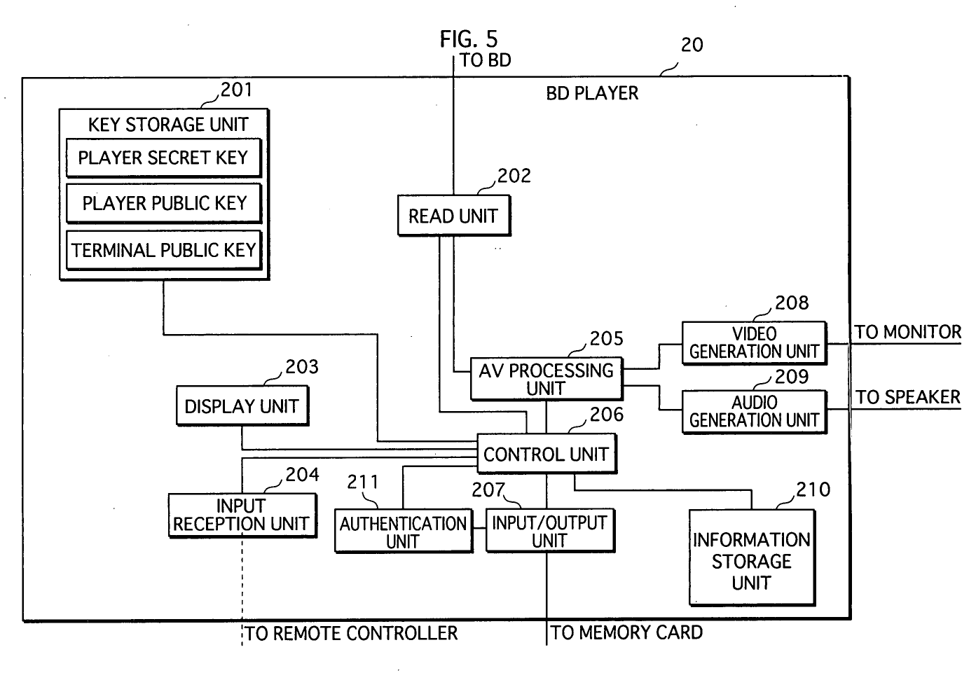

As shown in FIG. 5, the BD player 20 is roughly composed of a key storage unit 201, a read unit 202, a display unit 203, an input receiving unit 204, an AV processing unit 205, a control unit 206, an input/output unit 207, a video generation unit 208, an audio generation unit 209, an information storage unit 210, and an authentication unit 211. Also, a monitor 21 and a speaker (not shown) are connected to the BD player 20.

The BD player 20 is specifically a computer system that is roughly composed of a microprocessor, a ROM, and a RAM. The ROM stores computer programs. The functions of the BD player 20 are partially realized by the microprocessor operating in accordance with the computer programs.

### (1) Key Storage Unit 201

The key storage unit 201 is provided so as to allow no access from outside. As shown in FIG. 5, the key storage unit 201 prestores a player secret key, a player public key, and a terminal public key.

The player secret key is key data with a 160-bit length allocated to the BD player 20.

The player public key is a public key generated based on the player secret key using a public key encryption algorithm. The player public key is key data with a 160-bit length. Here, the public key encryption algorithm is the same as described above.

The terminal public key is key data with a 160-bit length generated by the terminal apparatus 10. The terminal public key is the same as described above.

### (2) Read Unit 202

The read unit 202 reads information from the BD 50 under control by the control unit 206, and outputs the read information to the control unit 206 or the AV processing unit 205.

### (3) Input/Output Unit 207

The input/output unit 207 bidirectionally transmits and receives information between the control unit 206 and the memory card 40 under control by the control unit 206, and between the authentication unit 211 and the memory card 40 under control by the authentication unit 211.

### (4) Authentication Unit 211

The authentication unit 211 performs mutual authentication with the memory card 40 via the input/output unit 207 when the memory card 40 is set in the BD player 20. Here, the authentication is of a challenge-response type. The authentication of a challenge-response type is not described in detail here as it is well known.

The authentication unit 211 sends a success message indicating a success of the mutual authentication to the control unit 206 when the mutual authentication between the authentication unit 211 and the memory card 40 is successful, and sends a failure message indicating a failure of the mutual authentication to the control unit 206 when the mutual authentication is unsuccessful.

When the mutual authentication is unsuccessful, the BD player 20 thereafter does not transmit and receive information to and from the memory card 40.

### (5) AV Processing Unit 205

The AV processing unit 205 receives a content key from the control unit 206, reads a piece of encrypted content from the BD 50 via the read unit 202, subjects the read piece of encrypted content to a decryption algorithm using the received content key to generate a piece of content. Here, the DES is used as the decryption algorithm. The AV processing unit 205 then separates the generated piece of content into compressed video information and compressed audio information, and outputs the compressed video information to the video generation unit 208 and the compressed audio information to the audio generation unit 209.

### (6) Video Generation Unit 208 and Audio Generation Unit 209

The video generation unit 208 receives the compressed video information from the AV processing unit 205, and decodes the compressed video information to generate video information. The video generation unit 208 then converts the generated video information into an analogue video signal, and outputs the video signal to the monitor 21.

The monitor 21 receives the video signal, and displays video.

The audio generation unit 209 receives the compressed audio information from the AV processing unit 205, and decodes the compressed audio information to generate audio information. The audio generation unit 209 then converts the generated audio information into an analogue audio signal, and outputs the audio signal to the speaker.

The speaker receives the audio signal, and outputs audio.

### (7) Control Unit 206

When the authentication performed by the authentication unit 211 in the BD player 20 is successful and the authentication performed by the authentication unit 403 in the memory card 40 is successful, the control unit 206 reads a plurality of content IDs from the BD 50 via the read unit 202, outputs the read content IDs to the display unit 203, and controls the display unit 203 to display the content IDs.

The control unit 206 then receives, from the user operating the remote controller 22, a content ID identifying a piece of content that the user wants to play back, via the remote controller 22 and the input reception unit 204.

The control unit 206 reads the rental information table 411 and the terminal signature data 413 from the memory card 40 via the input/output unit 207, reads the terminal public key from the key storage unit 201, and subjects the read rental information table and terminal signature data to the digital signature verification (first verification), using the read terminal public key.

When the first verification is unsuccessful, the control unit 206 further reads the player public key from the key storage unit 201, attempts to read the player signature data 414 from the memory card 40, and subjects the rental information table and the read player signature data to the digital signature verification (second verification), using the read player public key.

When the second verification is unsuccessful, or the attempt to read the player signature data 414 from the memory card 40 is in failure, the control unit 206 assumes that one, two, or all of the rental information table 411, the terminal signature data 413, and the player signature data 414 stored in the memory card 40 have been tampered, and aborts the content playback process.

When the first verification is successful, or when the second verification is successful, the control unit 206 extracts the viewing status corresponding to the received content ID from the read rental information table.

(a) When the extracted viewing status is “not-viewed”, the control unit 206 outputs a message indicating that a rental fee needs to be paid later to play back this piece of content, to the display unit 203, and controls the display unit 203 to display the message.

The control unit 206 receives, from the user operating the remote controller 22, an instruction as to whether the user intends to pay the rental fee later, via the remote controller 22 and the input reception unit 204.

Upon receipt of an instruction indicating that the user does not intend to pay the rental fee later, the control unit 206 aborts the content playback process.

Upon receipt of an instruction indicating that the user intends to pay the rental fee later, the control unit 206 changes the viewing status included in the read rental information table to “additionally-viewed”.

Following this, the control unit 206 reads the player secret key from the key storage unit 201, subjects the rental information table 411 including the changed viewing status to the digital signature algorithm, using the read player secret key, to generate player signature data.

The control unit 206 then writes the rental information table including the changed viewing status over the rental information table 411 held by the information storage unit 401 in the memory card 40. Also, the control unit 206 writes, as the player signature data 414, the generated player signature data into the information storage unit 401 in the memory card 40.

Here, when the user wants to play back two or more pieces of content identified by content IDs whose viewing status is “not-viewed” in the rental information table 411, the player signature data should already exist in the information storage unit 401 by the time when the second or subsequent piece of content is to be played back. In this case, the control unit 206 overwrites the generated player signature data over the player signature data already existing in the information storage unit 401.

Following this, the control unit 206 controls the read unit 202 to read a piece of encrypted content identified by the content ID received from the BD 50, and output the piece of encrypted content to the AV processing unit 205. The control unit 206 then extracts a content key corresponding to the content ID received from the rental information table, outputs the extracted content key to the AV processing unit 205, and controls the AV processing unit 205 to decrypt the received piece of encrypted content, using the extracted content key, so as to generate a piece of content. The control unit 206 also controls the AV processing unit 205 to separate the generated piece of content into compressed audio information and compressed video information, and output the compressed audio information and the compressed video information.

Following this, the control unit 206 updates a use count, a cumulative period of use, and a date of use corresponding to the received content ID, in the use-history information table 412 held by the information storage unit 401 in the memory card 40. To be more specific, the control unit 206 adds a value “1” to the use count. The control unit 206 calculates a time period from the start to the end of playback of the piece of content, and adds the calculated time period to the cumulative period of use. The control unit 206 sets the date of use at the present date, month, and year.

(b) When the extracted viewing status is “viewing-permitted” or “additionally-viewed”, the control unit 206 plays back the piece of content in the above-described way, and updates the use-history information table 412 held by the information storage unit 401 in the memory card 40.

### 1.6 Construction of the Server Apparatus 30

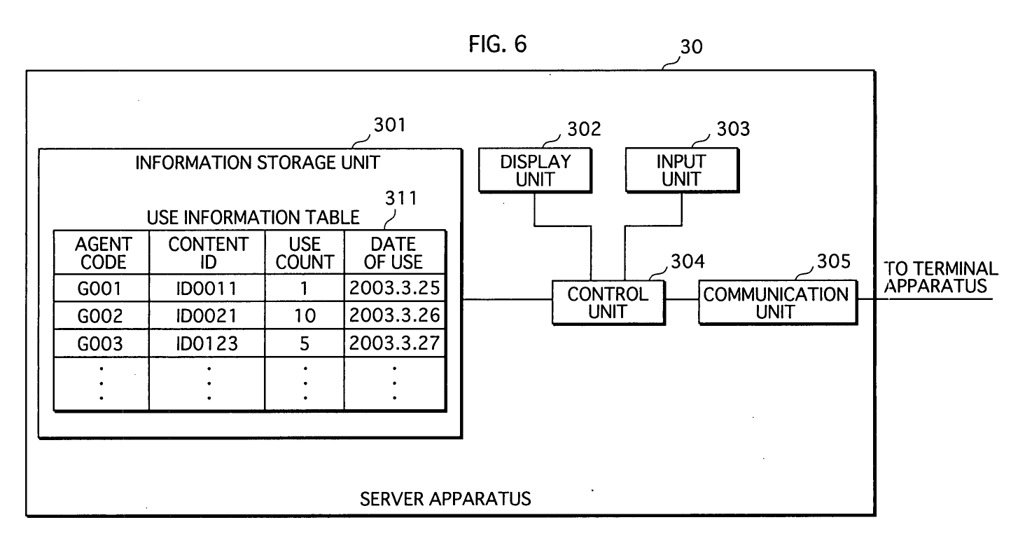

As shown in FIG. 6, the server apparatus 30 is roughly composed of an information storage unit 301, a display unit 302, an input unit 303, a control unit 304, and a communication unit 305.

The server apparatus 30 is specifically a computer system that is roughly composed of a microprocessor, a ROM, a RAM, a hard disk unit, a LAN-connected unit, a display unit, a keyboard, and a mouse. The RAM or the hard disk unit stores computer programs. The functions of the server apparatus 30 are realized by the microprocessor operating in accordance with the computer programs.

### (1) Information Storage Unit 301

As shown in FIG. 6, the information storage unit 301 has a use information table 311.

As shown in the figure, the use information table 311 has an area for storing a plurality of pieces of use information. Each piece of use information is composed of an agent code, a content ID, a use count, and a date of use.

The agent code is identification information identifying a rental agent.

The content ID is identification information identifying a piece of content played back by the user.

The use count is the number of times a piece of content identified by the corresponding content ID has been used.

The date of use is a date, month, and year when a piece of content identified by the corresponding content ID was lastly played back.

### (2) Control Unit 304

The control unit 304 receives an agent code and a report information table from the terminal apparatus 10 via the communication line 60 and the communication unit 305. Using the received agent code and report information table, the control unit 304 updates the use information table 311 held by the information storage unit 301 for each piece of report information included in the report information table. To be more specific, the control unit 304 extracts a piece of use information including both the received agent code and the content ID included in the piece of report information, from the use information table 311, and adds a value “1” to the use count included in the extracted piece of use information, and writes the date of use included in the extracted piece of use information over the date of use included in the piece of report information.

Also, the control unit 304 executes a process of charging a content use fee to each rental agent once at the end of every month, using each piece of use information stored in the use information table 311. In the fee charging process, the control unit 304 calculates a content use fee to be charged, in accordance with the use count included in the use information table 311, and then initializes the use information table 311.

### (3) Display Unit 302, Input Unit 303, and Communication Unit 305

The display unit 302 displays various information under control by the control unit 304.

The input unit 303 receives an input from the operator of the server apparatus 30, and outputs the received input to the control unit 304.

The communication unit 305 is connected to the terminal apparatus 10 via the communication line 60. The communication unit 305 transmits and receives information between the control unit 304 and the terminal apparatus 10.

### 1.7 Operations of the Rental System 1

The following describes the operations of the rental system 1, namely, an operation of the terminal apparatus 10 at the time of renting a BD, an operation of the BD player 20 at the time of playing back a piece of content stored in a BD, an operation of the terminal apparatus 10 at the time of returning a BD, an operation of the terminal apparatus 10 at the time of transmitting information relating to an amount of information used, and an operation of the server apparatus 30.

### (1) Operation of the Terminal Apparatus 10 at the Time of Renting a BD

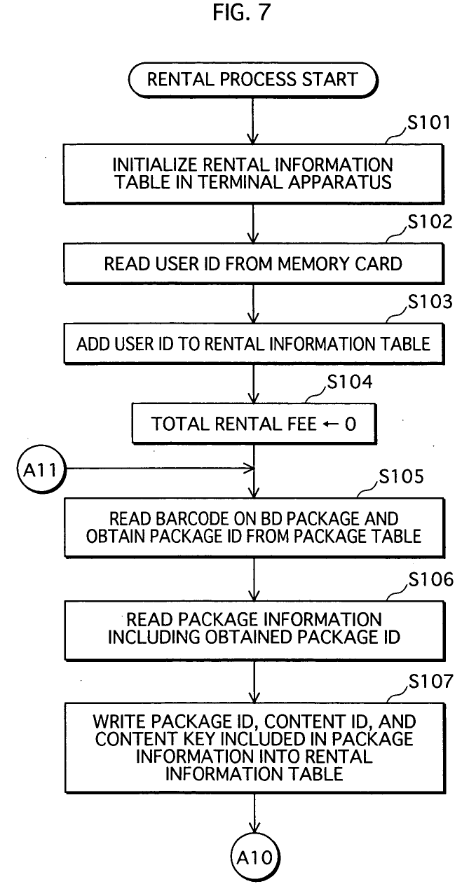

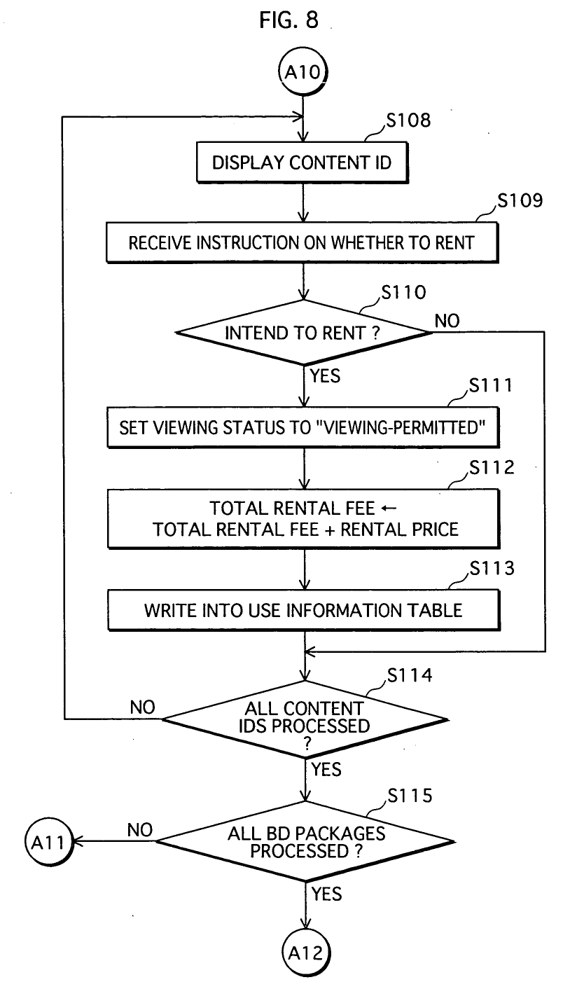

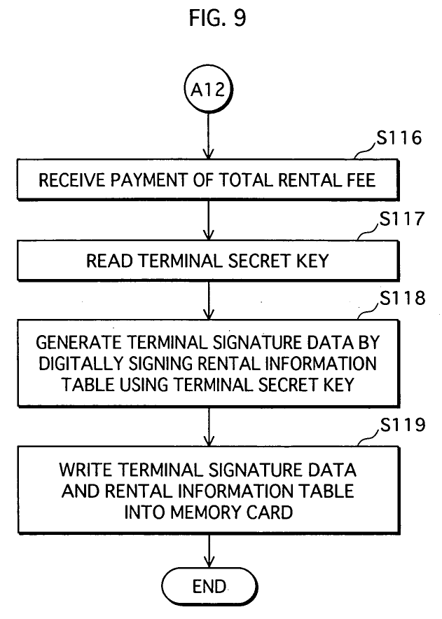

The following describes the operation of the terminal apparatus 10 when the BD 50 is rented to the user who is a member of the rental shop, with reference to a flowchart shown in FIGS. 7 to 9.

When the BD 50 is rented from the rental agent to the user, the memory card 40 owned by the user is set in the terminal apparatus 10, and mutual authentication is performed between the terminal apparatus 10 and the memory card 40. Here, the mutual authentication is assumed to be successful, and the following describes the processing executed after the successful mutual authentication.

The control unit 106 initializes the rental information table 135 and the user ID 136 in the information storage unit 112 (step S101). The control unit 106 then outputs a request to read a user ID to the memory card 40, via the read/write unit 105, and receives the user ID from the memory card 40 via the read/write unit 105 (step S102). The control unit 106 writes the received user ID into the information storage unit 112, as the user ID 136 (step S103).

The control unit 106 initializes a total amount showing a total of rental fees to be charged to the user, by setting a value of the total amount at “0” (step S104).

The barcode reader 111 optically reads a barcode printed on the surface of the BD package 59, by a shop clerk at the rental shop operating the terminal apparatus 10. The barcode reader 111 then generates read-information corresponding to the read barcode, and outputs the generated read-information to the barcode processing unit 110. The barcode processing unit 110 receives the read-information from the barcode reader 111, generates a package ID using the received read-information, and outputs the generated package ID to the control unit 106 (step S105).

Following this, the control unit 106 receives the package ID from the barcode processing unit 110, and reads a piece of package information including the received package ID from the package table 131 (step S106), and writes the package ID, the content ID, and the content key included in the read piece of package information, into the rental information table 135 (step S107).

The control unit 106 then outputs the content ID included in the piece of package information to the display unit 103 and the display unit 104, and the display unit 103 and the display unit 104 display the content ID (step S108). The control unit 106 receives an instruction indicating whether to rent a piece of content identified by the displayed content ID, from the input unit 102 (step S109).

Upon receipt of an instruction to rent the piece of content (step S110), the control unit 106 sets the viewing status corresponding to the content ID in the rental information table 135 to show “viewing-permitted” (step S111), adds a price corresponding to the content ID included in the piece of package information to the total amount (step S112), and updates relevant use information in the use information table 132 (step S113). Here, if all content IDs have not been subjected to the rental process (step S114), the control unit 106 returns to step S108, and repeats the above processing.

Upon receipt of an instruction not to rent the piece of content (step S110), the control unit 106 moves to step S114.

When all the content IDs have been subjected to the rental process (step S114), the control unit 106 judges whether all BD packages have been processed, and when judging negatively (step S115), the control unit 106 returns to step S105 and repeats the above processing.

When judging that all BD packages have been processed (step S115), the operator of the terminal apparatus 10 receives payment of the total amount of rental fees from the user (step S116). The control unit 106 reads the terminal secret key from the key storage unit 101 (step S117), and reads the rental information table 135. The control unit 106 subjects the read rental information table to the digital signature algorithm using the read terminal secret key, to generate terminal signature data (step S118). The control unit 106 writes the generated terminal signature data and the read rental information table to the memory card 40 via the read/write unit 105 (step S119).

### (2) Operation of the BD Player 20 for Playing Back Content in the BD

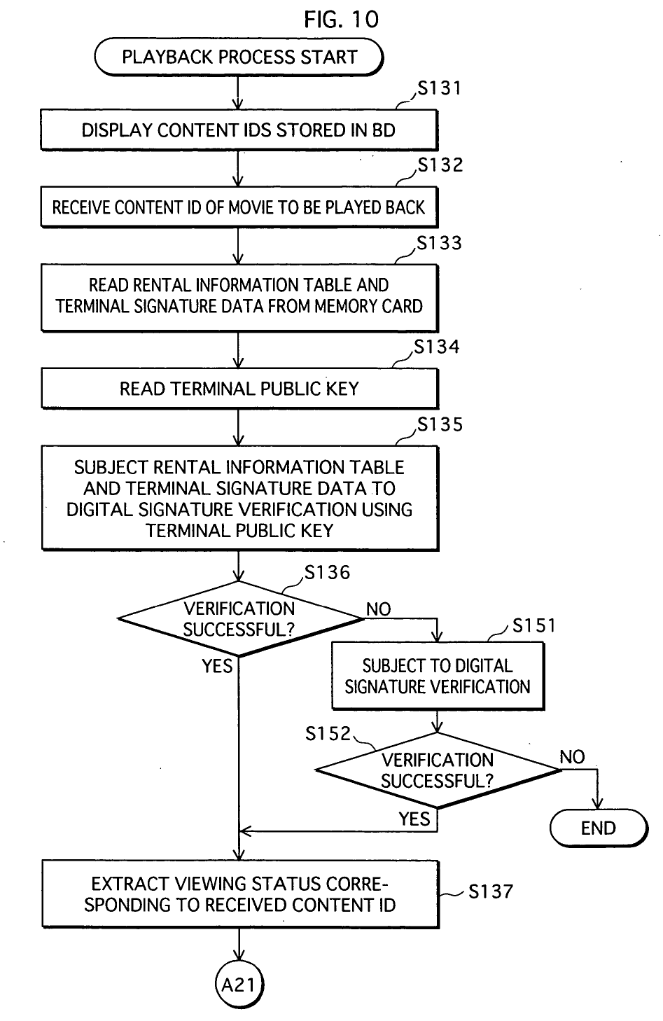

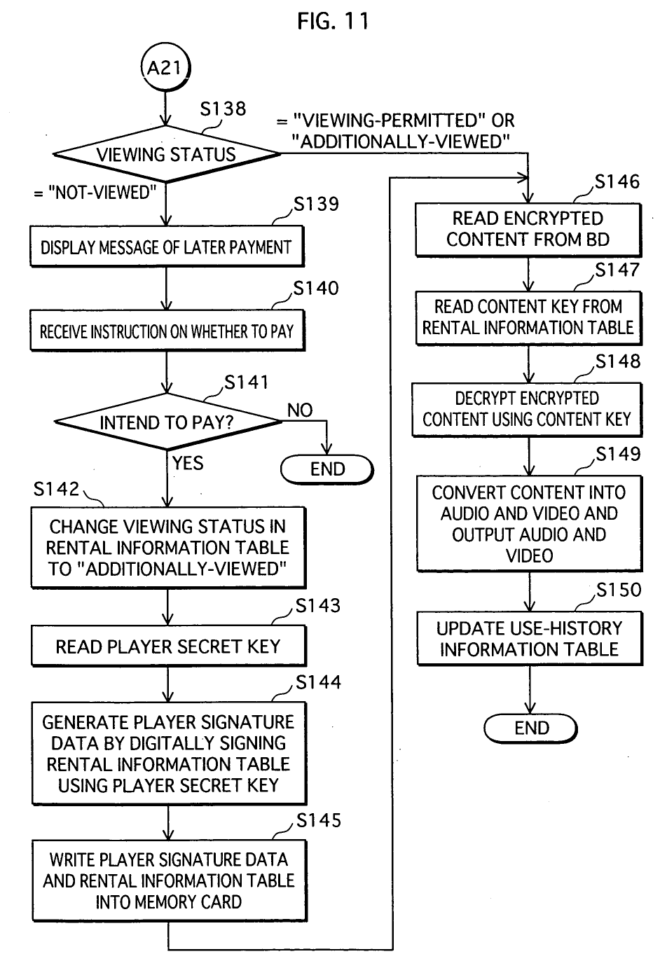

The following describes the operation of the BD player 20 for playing back a piece of encrypted content stored in the BD 50, with reference to a flowchart shown in FIGS. 10 and 11.

To play back a piece of encrypted content stored in the BD 50, the user sets the BD 50 and the memory card 40 in the BD player 20, so that mutual authentication is performed between the BD player 20 and the memory card 40. Here, the mutual authentication is assumed to be successful, and the following describes the processing executed after the successful mutual authentication.

The control unit 206 reads a plurality of content IDs from the BD 50 via the read/write unit 202, outputs the read plurality of content IDs to the display unit 203, and controls the display unit 203 to display the plurality of content IDs (step S131).

Following this, the control unit 206 receives, from the user operating the remote controller 22, a content ID identifying a piece of content that the user wants to play back, via the remote controller 22 and the input reception unit 204 (step S132).

The control unit 206 reads the rental information table 411 and the terminal signature data 413 from the memory card 40 via the input/output unit 207 (step S133), reads the terminal public key from the key storage unit 201 (step S134), and subjects the read rental information table and the terminal signature data to the digital signature verification (first verification) using the read terminal public key (step S135).

When the first verification is unsuccessful (step S136), the control unit 206 reads the player public key from the key storage unit 201, attempts to read the player signature data 414 from the memory card 40, and subjects the rental information table and the read player signature data to the digital signature verification (second verification) using the read player public key (step S151).

When the second verification is unsuccessful, or when the attempt to read the player signature data 414 from the memory card 40 is in failure (step S152), the control unit 206 assumes that one, two, or all of the rental information table 411, the terminal signature data 413, and the player signature data 414 stored in the memory card 40 have been tampered, and aborts the content playback process.

When the second verification is successful (step S152), or when the first verification is successful (step S136), the control unit 206 extracts the viewing status corresponding to the received content ID from the read rental information table (step S137).

When the extracted viewing status is “not-viewed” (step S138), the control unit 206 outputs a message indicating that a rental fee needs to be paid later to play back this piece of content, to the display unit 203, and controls the display unit 203 to display the message (step S139). Then, the control unit 206 receives, from the user operating the remote controller 22, an instruction indicating whether the user intends to pay the rental fee later, via the remote controller 22 and the input reception unit 204 (step S140).

Upon receipt of an instruction indicating that the user does not intend to pay the rental fee later (step S141), the control unit 206 aborts the content playback process.

Upon receipt of an instruction indicating that the user intends to pay the rental fee later (step S141), the control unit 206 changes the viewing status stored in the read rental information table to “additionally-viewed” (step S142). Following this, the control unit 206 reads the player secret key from the key storage unit 201 (step S143), subjects the rental information table 411 including the changed viewing status to the digital signature algorithm, using the read player secret key, to generate player signature data (step S144). Following this, the control unit 206 writes the rental information table including the changed viewing status over the rental information table 411 held by the information storage unit 401 in the memory card 40. Also, the control unit 206 writes the generated player signature data into the information storage unit 401 in the memory card 40 as the player signature data 414 (step S145).

The read unit 202 reads a piece of encrypted content identified by the received content ID from the BD 50 (step S146). The control unit 206 extracts a content key corresponding to the received content ID from the rental information table (step S147). The AV processing unit 205 decrypts the received piece of encrypted content, using the extracted content key, to generate a piece of content (step S148). The AV processing unit 205 separates the generated piece of content into compressed audio information and compressed video,information. The video generation unit 208 decodes the compressed video information to generate video information and converts the video information into an analogue video signal. The monitor 21 receives the video signal, and displays video. The audio generation unit 209 decodes the compressed audio information to generate audio information, and converts the audio information into an analogue audio signal. The speaker receives the audio signal, and outputs audio (step S149).

Following this, the control unit 206 updates the use count, cumulative period of use, and date of use corresponding to the received content ID in the use-history information table 412 held by the information storage unit 401 in the memory card 40 (step S150).

When the extracted viewing status is “viewing-permitted” or “additionally-viewed” (step S138), the control unit 206 plays back the piece of content (steps S146 to S149). Also, the control unit 206 updates the use-history information table 412 held by the information storage unit 401 in the memory card 40 (step S150).

### (3) Operation of the Terminal Apparatus 10 at the Time of Returning the BD

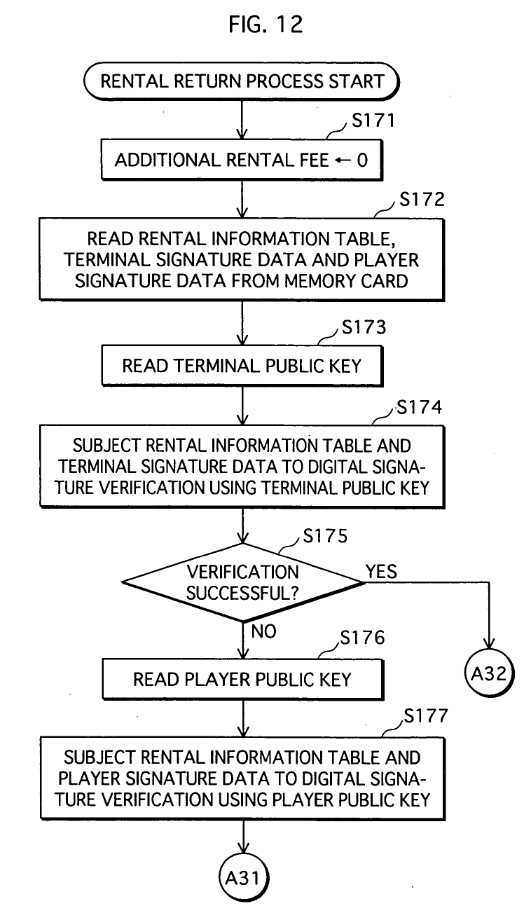

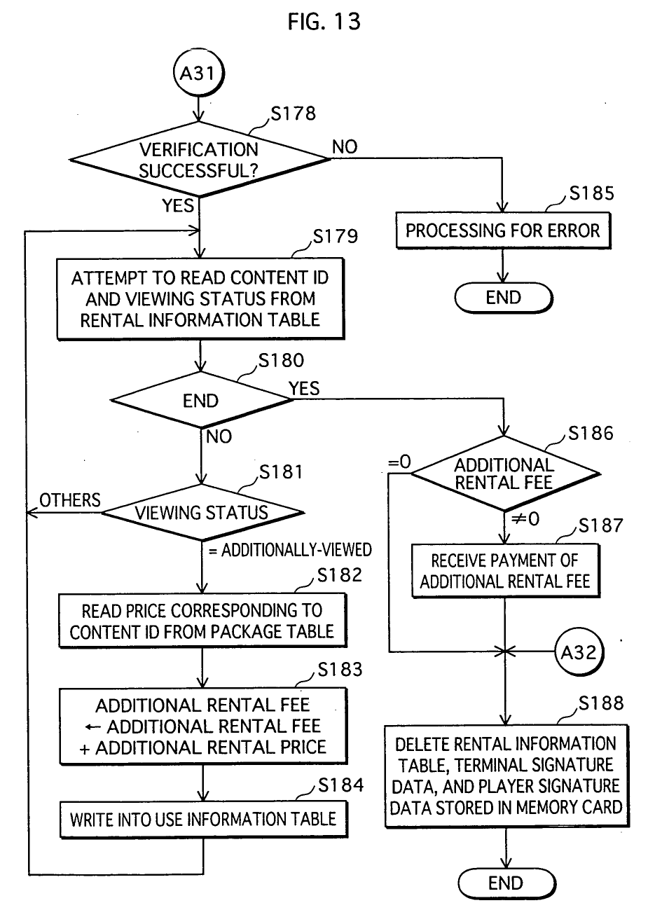

The following describes the operation of the terminal apparatus 10 at the time of returning the BD 50, with reference to a flowchart shown in FIGS. 12 and 13.

When the BD 50 is returned from the user to the rental agent, the memory card 40 owned by the user is set in the terminal apparatus 10, so that mutual authentication is performed between the terminal apparatus 10 and the memory card 40. Here, the mutual authentication is assumed to be successful, and the following describes the processing executed after the successful mutual authentication.

The control unit 106 initializes the additional rental fee by setting a value of the additional rental fee at “0” (step S171). The control unit 106 then reads the rental information table, the terminal signature data, and the player signature data from the memory card 40 via the read/write unit 105 (step S172).

The control unit 106 then reads the terminal public key from the key storage unit 101 (step S173), and subjects the read rental information table and the terminal signature data to the digital signature verification algorithm using the read terminal public key (step S174).

When the verification is successful (step S175), meaning that the rental information table has not been changed, the control unit 106 assumes that pieces of content whose rental fees are not paid have not been viewed. The control unit 106 therefore deletes the rental information table and the terminal signature data stored in the memory card 40 (step S188). The rental BD returning process ends.

When the verification is unsuccessful (step S175), the control unit 106 reads the player public key from the key storage unit 101 (step S176), and subjects the read rental information table and the player signature data to the digital signature verification algorithm using the read player public key (step S177).

When the verification is unsuccessful (step S178), the control unit 106 assumes that information has been written in an unauthorized manner into the memory card 40, and therefore executes processing for an error (step S185). The rental BD returning process ends.

On the other hand, when the verification is successful (step S178), the control unit 106 attempts to read the content ID and the viewing status from the rental information table (step S179), and when reading all content IDs has been completed (step S180), the control unit 106 moves to step S186.

When reading all content IDs has not been completed (step S180), the control unit 106 judges whether the viewing status is “additionally-viewed” (step S181).

When the viewing status is “additionally-viewed (step S181), the control unit 106 reads a price corresponding to the content ID from the package table 131 (step S182), and adds the read price to the additional rental fee (step S183), and writes the user ID, the content ID, the date of use, and the report code into the use information table 132 (step S184). The control unit 106 then returns to step S179, and repeats the above processing.

When the viewing status is other than “additionally-viewed” (step S181), the control unit 106 returns to step S179, and repeats the above processing.

Following this, the control unit 106 judges whether the additional rental fee is “0”, and when judging that the additional rental fee is not “0” (step S186), the operator of the terminal apparatus 10 receives payment of the additional rental fee from the user (step S187).

Finally, the control unit 106 deletes the rental information table, the terminal signature data, and the player signature data stored in the memory card 40 (step S188).

### (4) Operation of the Terminal Apparatus 10 for Transmitting Information Relating to Amount of Information Used

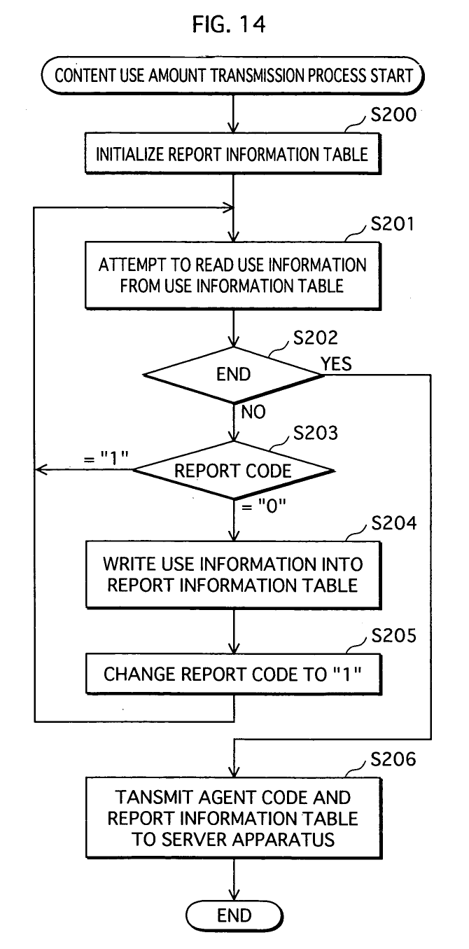

The following describes an operation of the terminal apparatus 10 for transmitting information relating to an amount of information used, with reference to a flowchart shown in FIG. 14.

The control unit 106 transmits, at regular intervals, i.e., once at the end of rental operations of every day, the report information table showing an amount of information used by content users, to the server apparatus 30 in the following way.

The control unit 106 initializes the report information table 134 held by the information storage unit 112 (step S200).

The control unit 106 attempts to read a piece of use information from the use information table 132 (step S201), and when reading all pieces of use information has been completed (step S202), reads the agent code 133 from the information storage unit 112. The control unit 106 then transmits the read agent code and the report information table 134 to the server apparatus 30 via the communication unit 107 and the communication line 60 (step S206). This completes the process executed by the terminal apparatus 10 for transmitting information relating to an amount of information used.

When reading of all pieces of use information has not been completed (step S202), the control unit 106 judges whether the report code included in the read piece of use information is “0” or “1”. When judging that the report code is “0” (step S203), the control unit 106 writes the user ID, content ID, and date of use included in the read piece of use information, into the report information table 134 (step S204), and changes the report content included in the use information table 132 to “1” (step S205). The control unit 106 then returns to step S201, and repeats the above processing.

When the report code is “1” (step S203), the control unit 106 returns to step S201, and repeats the above processing.

### (5) Operation of the Server Apparatus 30

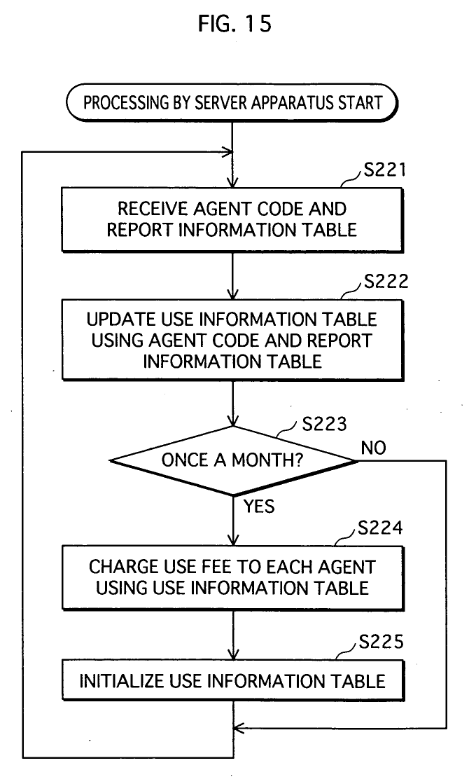

The following describes the operation of the server apparatus 30, with reference to a flowchart shown in FIG. 15.

The control unit 304 receives the agent code and the report information table from the terminal apparatus 10 via the communication line 60 and the communication unit 305 (step S221), and updates the use information table 311 held by the information storage unit 301, using the received agent code and the report information table, for each piece of report information included in the report information table (step S222).

Also, once at the end of every month (step S223), the control unit 304 executes a process for charging a content use fee to each rental agent (step S224), using each piece of use information stored in the use information table 311 (step S224). Following this, the control unit 304 initializes the use information table 311 (step S225).

The control unit 304 returns to step S221, and repeats the above processing.

### 1.8 Conclusions

As described above, a rental storage medium stores a plurality of pieces of content. When the rental agent rents the rental storage medium to the user, the terminal apparatus operated by the rental agent writes a plurality of pieces of rental information corresponding in one-to-one to the plurality of pieces of content into the memory card owned by the user. Each piece of rental information is composed of a content ID identifying the corresponding piece of content, a viewing status, and a content key. Here, the viewing status is either “viewing-permitted” or “not-viewed”. The viewing status “viewing-permitted” indicates that the rental fee for the corresponding piece of content has been paid. The viewing status “not-viewed” indicates that the rental fee for the corresponding piece of content has not been paid.

To play back a piece of content stored in the rental storage medium, the user sets the rental storage medium and the memory card in the BD player, and designates to the BD player, the piece of content to be played back. The BD player plays back the designated piece of content when the viewing status corresponding to the designated piece of content is “viewing-permitted” or “additionally-viewed”. When the viewing status is “not-viewed”, the BD player changes the viewing status to “additionally-viewed”, and then plays back the piece of content. When the piece of content is played back, the BD player writes use history information indicating the playback, to the memory card.

When the user returns the rental storage medium to the rental agent, the memory card is set in the terminal apparatus. When the viewing status “additionally-viewed” is stored in the memory card, the terminal apparatus calculates a rental fee corresponding to the piece of content, and charges the rental fee to the user. Also, the terminal apparatus reads use history information indicating playback of content, from the memory card, and internally stores the read use history information, as the use information.

The terminal apparatus transmits the use information to the server apparatus whose operations are managed by the content provider, at regular intervals.

The server apparatus internally stores the use information transmitted, and calculates a content use fee based on the internally stored use information, and charges the content use fee to the rental agent.

As described above, a rental storage medium stores a plurality of pieces of content. Therefore, if a rental storage medium rented by the user stores not only one piece of content that the user originally intends to view, but also other pieces of content relating to the one piece of content, the user can view the other pieces of content without being bothered to go to the rental shop again. This improves the user convenience, and also ensures better business opportunities for the rental agent.

Also, the content's copyright holder or the content provider can charge a content use fee to the rental agent based on the number of times each piece of content has been actually used.

Here, in a conventional case where one rental storage medium storing one piece of content is rented, the user for example may rent three rental storage mediums respectively storing three pieces of content, view one piece of content per day, and return the rental storage mediums four days after the rental start date. In such a case, the user is required to pay a rental fee of each of three rental storage mediums multplied by the number of rental days, i.e., by four. According to the present invention, however, the user is required to pay a rental fee calculated in accordance with an amount of information the user has actually viewed, which is reasonable to the user.

Moreover, the BD player is required to have a memory card set therein, to play back a piece of content stored in a BD. Therefore, for example, even if a malicious user steals a BD disc displayed at the rental shop and brings it his or her home, the user, without having authorized information stored in the memory card, cannot play back pieces of content stored in the stolen BD.

Also, the BD player may include only one input/output unit for memory cards. This input/output unit can read and write information to and from a memory card used in the copyright protection system, and also can read and write information to and from a memory card used in the rental system. Accordingly, the BD player does not need to be newly equipped with another input/output unit specially for a memory card used in the rental system.

Moreover, the rental shop can use membership cards also as rental cards, and therefore, can reduce the operating cost relating to such cards.

Also, the user does not have to carry a plurality of cards for these purposes.

The terminal apparatus subjects the rental information table to the digital signature algorithm, to generate terminal signature data, and the BD player verifies whether the rental information table has been tampered by a malicious third party, using the rental information table and the terminal signature data. Therefore, unauthorized use of the rental information table can be prevented. To be more specific, even when the third party tries altering the viewing status “not-viewed” to “viewing-permitted”, for the purpose of playing back a piece of content without paying its rental fee, the BD player can detect this alteration. When detecting the alteration, the BD player does not play back the piece of content.

Also, the BD player subjects the rental information table to the digital signature algorithm, to generate player signature data, and the terminal apparatus verifies whether the rental information table has been tampered by a malicious third party, using the rental information table and the terminal signature data. Therefore, unauthorized use of the rental information table can be prevented. To be more specific, even when the third party tries altering the viewing status “additionally-viewed” to “not-viewed”, for the purpose of playing back a piece of content without paying its rental fee, the terminal apparatus can detect this alteration.

### 1.9 Other Modifications

Although the present invention is described based on the above embodiment, it should be clear that the present invention is not limited to specific examples shown in the above embodiment. The following modifications are also possible.

(1) The memory card may have an electronic money function. Here, electronic money is information used instead of real money, and the electronic money function is a method for charging a rental fee not in cash but in electronic money.

In this case, when the rented BD is returned, a process of charging a rental fee is not performed using the terminal apparatus. Instead, the terminal apparatus writes a rental fee for each piece of content in correspondence with its content ID, to the memory card. When playing back a piece of content identified by a content ID corresponding to the viewing status “not-viewed”, the BD player reads the corresponding rental fee from the memory card, and charges the rental fee using the electronic money held by the memory card.

(2) When the rented BD is returned, the terminal apparatus may calculate a rental fee based on the use count indicating the number of times each piece of content has been played back included in the use-history information table, and may charge the calculated rental fee to the user. Also, the terminal apparatus may calculate a rental fee based on the cumulative period of use included in the use-history information table, and may charge the calculated rental fee to the user. Also, the terminal apparatus may hold a rental start date and a rental end date, calculate a rental fee based on a rental period from the rental start date and the rental end date, and charge the calculated rental fee to the user.

Further, when the BD player has a clock function, the BD player may store a date and time at which a piece of content is actually used. In this case, the terminal apparatus calculates the number of days on which the piece of content is used, using the date and time stored in the memory card, calculate a rental fee based on the calculated number of days, and charge the calculated rental fee to the user. For example, when the rental period from the rental start date to the rental end date is seven days but the piece of content is actually used only on one day, the terminal apparatus can charge a rental fee of only one day on which the piece of content is actually used.

(3) Although the above embodiment describes the case where the terminal apparatus deletes the rental information table stored in the memory card when the rented BD is returned, the terminal apparatus may change the viewing status for each piece of content included in the rental information table to “previously-used” indicating that the corresponding piece of content was previously used. In this case, the terminal apparatus deletes the content key included in the rental information table. Also, even if the BD player is requested by the user to play back a piece of content identified by a content ID corresponding to the viewing status “previously-used”, the BD player does not accept this request, and does not play back the piece of content.

Also, when the BD player is requested by the user to use a piece of content identified by a content ID corresponding to the viewing status “previously-used”, the BD player may display, to the user, a message indicating that the piece of content was previously used. After confirming that the user still wants to use that piece of content, the BD player may play back the piece of content.

(4) The terminal apparatus may write the viewing status “viewing-not-permitted” in the rental information table to be written to the memory card. Even if the BD player is requested by the user to play back a piece of content identified by a content ID corresponding to the viewing status “viewing-not-permitted”, the BD player does not accept this request, and does not play back the piece of content.

In this way, the viewing status “viewing-not-permitted” may be provided for the purpose of limiting playback of a piece of content.

For example, the terminal apparatus may change the viewing status “viewing-not-permitted” to “not-viewed” depending on the age of the user. To be more specific, for a certain piece of content, the terminal apparatus may write the viewing status “viewing-not-permitted” when the user is younger than 18 years old, and may write the viewing status “not-viewed” when the user is 18 years old or older.

For a piece of content that is yet to be released at a movie theater, the terminal apparatus may write the viewing status “viewing-not-permitted” and write the viewing status “not-viewed” after the piece of content is released at a movie theater.

(5) Although the above embodiment describes the case where the encryption algorithm and the decryption algorithm comply with the DES, other cryptographic techniques may be used.

Also, although the above embodiment describes the case where the digital signature algorithm and the digital signature verification algorithm comply with the ElGamal signature scheme which bases its security on the discrete logarithm problem on elliptic curves, other signing methods may be used.

(6) The terminal apparatus may not write the use-history information table to the memory card when the BD is rented. In this case, the BD player does not write the use count, cumulative period of use, and date of use at the time when a piece of content is played back.

(7) Although the above embodiment describes the case where the memory card 40 is provided to the user as being bundled with the BD player 20, the present invention should not be limited to such. For example, the rental agent may provide the memory card storing the user ID, when the user registers as a member of the rental shop.

(8) Although the above embodiment describes the case where the operation of the terminal apparatus 10 at the time of renting a BD is to optically read a barcode printed on the surface of the BD package 59 to obtain a package ID, the terminal apparatus 10 may include a read unit for a BD, and the BD wrapped in the BD package 59 may be set in the terminal apparatus 10 by the operation of the shop clerk at the rental shop, so that the read unit reads the package ID 54 stored in the BD.

(9) Although the above embodiment describes the case where the rental information table 411 stored in the memory card 40 is given signature data generated by the terminal apparatus 10 and signature data generated by the BD player 20, tampering of the rental information table 411 by a malicious third party can be prevented. However, not only tampering but also wiretapping of the content key included in the rental information table needs to be prevented. For this purpose, the following construction may be employed.

The authentication of a challenge-response type is performed between the terminal apparatus 10 and the memory card 40, and between the BD player 20 and the memory card 40, and only a successfully authenticated apparatus is permitted to read and write information stored in the memory card 40. For reading and writing information stored in the memory card 40, the SAC (Secure Authentication Channel) is established between the terminal apparatus 10 and the memory card 40, and between the BD player 20 and the memory card 40, so that communication between them is in an encrypted form.

Only the terminal apparatus or the BD player that is successfully authenticated is permitted to write information to the memory card 40. An apparatus that is not successfully authenticated is not permitted to write information to the memory card 40. In this case, therefore, the terminal apparatus and the BD player do not need to generate signature data and write the signature data to the memory card 40. In this case too, however, such generation and attaching of signature data by the terminal apparatus can produce the effect of preventing tampering by an unauthorized BD player. In this case, the terminal apparatus 10 may not hold a public key of the BD player 20 for signature verification, the BD player 20 may not hold a public key of the terminal apparatus 10, and the memory card 40 may hold a public key of the terminal apparatus 10 for signature verification.

(10) Although the above embodiment describes the case where the terminal apparatus 10 holds a public key of the BD player 20 for signature verification and the BD player 20 holds a public key of the terminal apparatus 10, the memory card 40 may store the public keys of these apparatuses for signature verification. In this case, the terminal apparatus 10 and the BD player 20 read each other's public key from the memory card 40 and uses the public key.

(11) Although the above embodiment describes the case where the content key is stored in the package table 131 within the terminal apparatus 10 as a plaintext, the content key may be stored in the terminal apparatus 10 in a protected form for the purpose of preventing the leakage of the content key in case the terminal apparatus 10 is attacked by a malicious third party.

For example, the content key may be encrypted using a terminal public key. In this case, when the BD is rented, the control unit 106 reads the rental information table and then decrypts the encrypted content key using the terminal secret key, and writes the decrypted content key to the memory card 40 via the read/write unit 105. It should be noted here that the key storage unit 101, the control unit 106, and the read/write unit 105 are tamper-resistant for the purpose of preventing attack from outside.

(12) Although the above embodiment describes the case where the BD player receives for playing back a piece of content, from the user operating the remote controller, a content ID identifying a piece of content that the user wants to play back out of a plurality of content IDs displayed, the present invention should not be limited to such.

For example, menu data for displaying a list of pieces of content may be stored in a BD, and the BD player 20 may display a menu by playing back the menu data. Then, the user may operate the remote controller to select a piece of content that the user wants to play back, and the BD player 20 may obtain a content ID identifying the selected piece of content from information included in the menu data.

(13) Although in the above embodiment it is impossible to tamper the rental information table, it is possible for a malicious third party to delete the rental information table. If the rental information table is deleted, a rental fee cannot be charged using the terminal apparatus 10 at the time when a rented BD is returned. To solve this problem, the terminal apparatus 10 at the rental shop may store information relating to a rented package when a BD is rented. If the rental information table has been deleted from the memory card when the BD is returned, the terminal apparatus 10 may assume that all pieces of content have been viewed, and charge a rental fee accordingly.

It should be noted here that by introducing the mechanism in which only a successfully authenticated terminal apparatus and a successfully authenticated BD player can perform reading and writing as described in the item (9), such a problem as described above can be eliminated.

(14) The present invention may also be realized by methods described in the above embodiment. Also, the methods may be realized by computer programs to be executed on a computer, or by digital signals that are made up of the computer programs.

Further, the present invention may be realized by a computer-readable storage medium storing the computer programs or the digital signals. Examples of the computer-readable recording medium include a flexible disk, a hard disk, a CD-ROM, an MO, a DVD, a DVD-ROM, a DVD-RAM, a BD, and a semiconductor memory. Also, the present invention may be realized by the computer programs, or by the digital signals stored in such a storage medium.

Also, the present invention may be realized by the computer programs or the digital signals being transmitted via an electric communication line, a wireless or cable communication line, or a network such as the Internet.

Moreover, the present invention may be realized by a computer system including a microprocessor and a memory. Here, the memory may store the computer programs, and the microprocessor may operate in accordance with the computer programs.

By storing the computer programs or the digital signals in any of the storage mediums listed above and transferring the storage mediums to an independent computer system, or by transmitting the computer programs or the digital signals to an independent computer system via a network, the computer programs or the digital signals may be executed in the independent computer system.

(15) The above embodiment of the present invention and the modifications may be combined.

### 1.10 Effects of the Invention

As described above, the present invention provides a storage medium rental system in which a rental agent rents a portable storage medium to a user, including: the storage medium prestoring a plurality of pieces of content data corresponding in one-to-one to a plurality of pieces of digital work; a portable semiconductor memory; a rental-shop apparatus that, when the storage medium is rented to the user, writes a plurality of pieces of right information corresponding in one-to-one to the plurality of pieces of digital work into an area of the semiconductor memory, each piece of right information showing a right on playback; and a playback apparatus that, when the storage medium and the semiconductor memory are set therein and a designation of one of the pieces of digital work is given by the user, reads the corresponding piece of right information from the area of the semiconductor memory, judges whether playback of the designated piece of digital work is permitted based on the read piece of right information, and when judging affirmatively, reads the corresponding piece of content data from the storage medium and plays back the designated piece of digital work based on the read piece of content data. The present invention also provides a rental-shop apparatus that manages rental of a portable storage medium storing a plurality of pieces of content data corresponding in one-to-one to a plurality of pieces of digital work, including: a generation unit operable to generate a plurality of pieces of right information corresponding in one-to-one to the plurality of pieces of digital work based on the plurality of pieces of content data stored in the storage medium, each piece of right information showing a right on playback; and a writing unit operable to write the plurality of pieces of right information generated by the generation unit, to a portable semiconductor memory. The present invention also provides a playback apparatus that plays back a piece of digital work from a portable storage medium storing a plurality of pieces of content data corresponding in one-to-one to a plurality of pieces of digital work, including: a read unit operable to, when a designation of one of the pieces of digital work is given by a user, read a piece of right information corresponding to the designated piece of digital work, from a semiconductor memory storing a plurality of pieces of right information corresponding in one-to-one to the plurality of pieces of digital work, each piece of right information showing a right on playback; a judgment unit operable to judge whether playback of the designated piece of digital work is permitted based on the piece of right information read by the read unit; and a playback unit operable to, when the judgment unit judges affirmatively, read the corresponding piece of content data from the storage medium and play back the designated piece of digital work based on the read piece of content data.

According to these constructions, the playback apparatus plays back a piece of digital work that the user wants, out of a plurality of pieces of digital work stored in one rental storage medium rented from the rental agent, and therefore, the user convenience is improved as the user does not have to go to the rental shop many times. Also, the playback apparatus judges whether a piece of digital work is permitted to be played back using the corresponding piece of right information stored in the memory card, and therefore, unauthorized playback of digital work can be prevented, thereby enabling the rental agent to easily protect digital work.

Here, each piece of content data stored in the storage medium may include a piece of encrypted digital work that has been generated by encrypting the corresponding piece of digital work using key information, each piece of right information generated by the generation unit may include the key information and playback information indicating whether playback of the corresponding piece of digital work is permitted, and the writing unit may write the plurality of pieces of right information each including the key information and the playback information to the semiconductor memory. Also, each piece of content data stored in the storage medium may include a piece of encrypted digital work that has been generated by encrypting the corresponding piece of digital work using key information, each piece of right information stored in the storage medium may include the key information and playback information indicating whether playback of the corresponding piece of digital work is permitted, the read unit reads the piece of right information including the key information and the playback information from the semiconductor memory, the judgment unit may judge whether playback of the designated piece of digital work is permitted based on the playback information included in the read piece of right information, and the playback unit may decrypt the piece of encrypted digital work included in the piece of content data, based on the key information included in the read piece of right information, to generate a piece of digital work, and plays back the generated piece of digital work.

According to these constructions, the rental-shop apparatus writes key information used to encrypt each piece of digital work and playback information indicating whether playback of each piece of digital work is permitted, to the semiconductor memory. Also, the playback apparatus judges whether a piece of digital work is permitted to be played back using the playback information and plays back the piece of digital work generated by decrypting a piece of encrypted digital work using the key information. Therefore, unauthorized playback of digital work can be prevented.

Here, the generation unit may generate, as the playback information, paid-information for a piece of digital work whose rental fee has been paid by a user, the paid-information indicating that the payment has been made, and generate, as the playback information, unpaid-information for a piece of digital work whose rental fee has not been paid by the user, the unpaid-information indicating that the payment has not been made, and at least one of the pieces of right information to be written by the writing unit may include the key information and the paid-information, and the remaining pieces of right information each may include the key information and the unpaid-information. Also, at least one of the pieces of right information stored in the semiconductor memory may include the key information, and paid-information as the playback information, the paid-information indicating that payment of a rental fee for the corresponding piece of digital work has been made, and the remaining pieces of right information each may include the key information and unpaid-information as the playback information, the unpaid-information indicating that payment of a rental fee for the corresponding piece of digital work has not been made, the judgment unit may judge whether the playback information included in the read piece of right information is the paid-information, or the unpaid-information, and the playback unit may rewrite, when the playback information included in the read piece of right information is judged to be the unpaid-information, the unpaid-information stored in the semiconductor memory to played- information indicating that the corresponding piece of digital work has been played back.

According to these constructions, the rental-shop apparatus writes “paid-information” indicating that a rental fee for a piece of digital work has been paid by the user or “unpaid-information” indicating that a rental fee for a piece of digital work has not been paid by the user, to the semiconductor memory. When a piece of digital work is played back, the playback apparatus changes the corresponding “unpaid-information” stored in the semiconductor memory to “played-information” indicating that the piece of digital work has been played back. This ensures detecting of a piece of digital work that has been played back without its rental fee being paid by the user.

Here, the semiconductor memory may store played-information in correspondence with a piece of digital work whose rental fee has not been paid, the played-information indicating that the corresponding piece of digital work has been played back by a playback apparatus, and the rental-shop apparatus may further include a charging unit operable to, when the storage medium is returned, read the played-information from the semiconductor memory, calculate a rental fee based on the read played-information, and charge the calculated rental fee to the user.

According to this construction, the rental-shop apparatus can calculate a rental fee for a piece of digital work that has been played back without its rental fee being paid by the user, and charge the rental fee to the user.

Here, the played-information may indicate a playback count of the corresponding piece of digital work by the playback apparatus, or a cumulative period of playback of the corresponding piece of digital work by the playback apparatus, and the charging unit may calculate the rental fee based on the playback count or the cumulative period of playback. Also, the playback unit may calculate, as the played-information, a playback count of the corresponding piece of digital work, or a cumulative period of playback of the corresponding piece of digital work, and rewrite the unpaid-information stored in the semiconductor memory to the playback count or the cumulative period of playback.

According to these constructions, the playback apparatus writes the playback count and the cumulative period of playback of a piece of digital work to the semiconductor memory. The rental-shop apparatus calculates the rental fee based on the playback count and the cumulative period of playback. Therefore, the criterion used for calculating the rental fee can be clarified.

Here, the rental-shop apparatus may further includes a deletion unit operable to, when the storage medium is returned, delete the key information written in the semiconductor memory.

According to this construction, the rental-shop apparatus deletes the key information from the semiconductor memory. Therefore, unauthorized decryption of digital work by unauthorized use of the key information can be prevented.

Here, the semiconductor memory may store electronic money information to be used instead of real money, and the playback apparatus may further include a charging unit operable to, when the playback information included in the read piece of right information is judged to be the unpaid-information, calculate a fee for playback of the corresponding piece of digital work, and deduct an amount corresponding to the calculated fee from the electronic money information stored in the semiconductor memory.

According to this construction, the playback apparatus deducts an amount corresponding to a rental fee from electronic money information stored in the semiconductor memory. Therefore, the process of charging a rental fee can be simplified.

Here, the playback apparatus may further include a writing unit operable to write use information indicating that the designated piece of digital work has been played back, to the semiconductor memory. The semiconductor memory may store, in correspondence with a piece of digital work, use information indicating that the piece of digital work has been played back by a playback apparatus, and the rental-shop apparatus may further include a transmission unit operable to read the use information from the semiconductor memory and transmit the use information in correspondence with the piece of digital work, to a server apparatus. Also, the present invention provides a server apparatus that obtains, from a rental agent, information about use of a storage medium, including: a reception unit operable to receive use information indicating that a piece of digital work stored in the storage medium has been played back, from a rental-shop apparatus that manages rental of the storage medium to a user; and a charging unit operable to calculate a fee for provision of the storage medium to the rental agent, and charge the calculated fee to the rental agent.

According to these constructions, the playback apparatus writes use information indicating playback of a piece of digital work to the semiconductor memory. The rental shop apparatus transmits the use information to the server apparatus in correspondence with the piece of digital work. The server apparatus calculates a fee for provision of the rental storage medium to the rental agent, using the received use information, and charges the calculated fee to the rental agent. This ensures charging the rental agent the fee for provision of the rental storage medium from the content provider to the rental agent.

Although the present invention has been fully described byway of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A storage medium rental system in which a rental agent rents a portable storage medium to a user, comprising:
the storage medium prestoring a plurality of pieces of content data corresponding in one-to-one to a plurality of pieces of digital work;
a portable semiconductor memory;
a rental-shop apparatus that, when the storage medium is rented to the user, writes a plurality of pieces of right information corresponding in one-to-one to the plurality of pieces of digital work into an area of the semiconductor memory, each piece of right information showing a right on playback; and
a playback apparatus that, when the storage medium and the semiconductor memory are set therein and a designation of one of the pieces of digital work is given by the user, reads the corresponding piece of right information from the area of the semiconductor memory, judges whether playback of the designated piece of digital work is permitted based on the read piece of right information, and when judging affirmatively, reads the corresponding piece of content data from the storage medium and plays back the designated piece of digital work based on the read piece of content data.

2. A rental-shop apparatus that manages rental of a portable storage medium storing a plurality of pieces of content data corresponding in one-to-one to a plurality of pieces of digital work, comprising:
a generation unit operable to generate a plurality of pieces of right information corresponding in one-to-one to the plurality of pieces of digital work based on the plurality of pieces of content data stored in the storage medium, each piece of right information showing a right on playback; and
a writing unit operable to write the plurality of pieces of right information generated by the generation unit, to a portable semiconductor memory.

3. The rental-shop apparatus of claim 2, wherein
each piece of content data stored in the storage medium includes a piece of encrypted digital work that has been generated by encrypting the corresponding piece of digital work using key information,
each piece of right information generated by the generation unit includes the key information and playback information indicating whether playback of the corresponding piece of digital work is permitted, and
the writing unit writes the plurality of pieces of right information each including the key information and the playback information to the semiconductor memory.

4. The rental-shop apparatus of claim 3, wherein
the generation unit generates, as the playback information, paid-information for a piece of digital work whose rental fee has been paid by a user, the paid-information indicating that the payment has been made, and generates, as the playback information, unpaid-information for a piece of digital work whose rental fee has not been paid by the user, the unpaid-information indicating that the payment has not been made, and
at least one of the pieces of right information to be written by the writing unit includes the key information and the paid-information, and the remaining pieces of right information each include the key information and the unpaid-information.

5. The rental-shop apparatus of claim 4, wherein
the semiconductor memory stores played-information in correspondence with a piece of digital work whose rental fee has not been paid, the played-information indicating that the corresponding piece of digital work has been played back by a playback apparatus, and
the rental-shop apparatus further comprises a charging unit operable to, when the storage medium is returned, read the played-information from the semiconductor memory, calculate a rental fee based on the read played-information, and charge the calculated rental fee to the user.

6. The rental-shop apparatus of claim 5, wherein
the played-information indicates a playback count of the corresponding piece of digital work by the playback apparatus, or a cumulative period of playback of the corresponding piece of digital work by the playback apparatus, and
the charging unit calculates the rental fee based on the playback count or the cumulative period of playback.

7. The rental-shop apparatus of claim 5, further comprising
a deletion unit operable to, when the storage medium is returned, delete the key information written in the semiconductor memory.

8. The rental-shop apparatus of claim 3, wherein
the semiconductor memory stores, in correspondence with a piece of digital work, use information indicating that the piece of digital work has been played back by a playback apparatus, and
the rental-shop apparatus further comprises a transmission unit operable to read the use information from the semiconductor memory and transmit the use information in correspondence with the piece of digital work, to a server apparatus.

9. A playback apparatus that plays back a piece of digital work from a portable storage medium storing a plurality of pieces of content data corresponding in one-to-one to a plurality of pieces of digital work, comprising:
a read unit operable to, when a designation of one of the pieces of digital work is given by a user, read a piece of right information corresponding to the designated piece of digital work, from a semiconductor memory storing a plurality of pieces of right information corresponding in one-to-one to the plurality of pieces of digital work, each piece of right information showing a right on playback;
a judgment unit operable to judge whether playback of the designated piece of digital work is permitted based on the piece of right information read by the read unit; and
a playback unit operable to, when the judgment unit judges affirmatively, read the corresponding piece of content data from the storage medium and play back the designated piece of digital work based on the read piece of content data.

10. The playback apparatus of claim 9, wherein
each piece of content data stored in the storage medium includes a piece of encrypted digital work that has been generated by encrypting the corresponding piece of digital work using key information,
each piece of right information stored in the storage medium includes the key information and playback information indicating whether playback of the corresponding piece of digital work is permitted,
the read unit reads the piece of right information including the key information and the playback information from the semiconductor memory,
the judgment unit judges whether playback of the designated piece of digital work is permitted based on the playback information included in the read piece of right information, and
the playback unit decrypts the piece of encrypted digital work included in the piece of content data, based on the key information included in the read piece of right information, to generate a piece of digital work, and plays back the generated piece of digital work.

11. The playback apparatus of claim 10, wherein
at least one of the pieces of right information stored in the semiconductor memory includes the key information, and paid-information as the playback information, the paid-information indicating that payment of a rental fee for the corresponding piece of digital work has been made, and the remaining pieces of right information each include the key information and unpaid-information as the playback information, the unpaid-information indicating that payment of a rental fee for the corresponding piece of digital work has not been made,
the judgment unit judges whether the playback information included in the read piece of right information is the paid-information, or the unpaid-information, and
the playback unit rewrites, when the playback information included in the read piece of right information is judged to be the unpaid-information, the unpaid-information stored in the semiconductor memory to played-information indicating that the corresponding piece of digital work has been played back.

12. The playback apparatus of claim 11, wherein
the playback unit calculates, as the played-information, a playback count of the corresponding piece of digital work, or a cumulative period of playback of the corresponding piece of digital work, and rewrites the unpaid-information stored in the semiconductor memory to the playback count or the cumulative period of playback.

13. The playback apparatus of claim 11, wherein
the semiconductor memory stores electronic money information to be used instead of real money, and
the playback apparatus further comprises a charging unit operable to, when the playback information included in the read piece of right information is judged to be the unpaid-information, calculate a fee for playback of the corresponding piece of digital work, and deduct an amount corresponding to the calculated fee from the electronic money information stored in the semiconductor memory.

14. The playback apparatus of claim 10, further comprising
a writing unit operable to write use information indicating that the designated piece of digital work has been played back, to the semiconductor memory.

15. A server apparatus that obtains, from a rental agent, information about use of a storage medium, comprising:
a reception unit operable to receive use information indicating that a piece of digital work stored in the storage medium has been played back, from a rental-shop apparatus that manages rental of the storage medium to a user; and
a charging unit operable to calculate a fee for provision of the storage medium to the rental agent, and charge the calculated fee to the rental agent.
